(19) United States
(12) Patent Application Publication
(10) Pub. No.: US 2009/0307185 A1
(43) Pub. Date: Dec. 10, 2009

(54) METHOD FOR SEAMLESS PLAYBACK OF MULTIPLE MULTIMEDIA FILES

(75) Inventors: Shun-Yu Chuang, Yunlin County (TW); Shu-Fa Lin, Kaohsiung City (TW); Yu-Chi Chen, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: SUNPLUS TECHNOLOGY CO., LTD., Hsinchu (TW)

(21) Appl. No.: 12/344,254

(22) Filed: Dec. 25, 2008

(30) Foreign Application Priority Data
Jun. 10, 2008 (TW) 97121569

(51) Int. Cl. G06F 17/30

(52) U.S. Cl. 707/2; 707/E17.009

(57) ABSTRACT

A method for seamless playback of multiple multimedia files is provided. First, a first multimedia file and a second multimedia file are pre-analyzed to establish a playing list. Next, index content of the first multimedia file and the second multimedia file are referred to, so as to establish a first random access table and a second random access table. Then, the multiple multimedia files are played according to the play list, the first random access table, and the second random access table. Accordingly, the multiple multimedia files can be played seamlessly while the video and audio data are kept synchronized, such that the continuity for viewing multimedia files is improved.

### CROSS-REFERENCE TO RELATED APPLICATION

This application claims the priority benefit of Taiwan application serial no. 97121569, filed on Jun. 10, 2008. The entirety of the above-mentioned patent application is hereby incorporated by reference herein and made a part of specification.

### BACKGROUND OF THE INVENTION

1. Field of the Invention

The present invention generally relates to a playback method for multimedia files, and more particularly, to a seamless playback method adapted for continuously playing a plurality of multimedia files.

2. Description of Related Art

Responding to the coming of the high definition video times, the video data volume for a same playing time length has become greater and greater. When recorded with a conventional audio video interleave (AVI) format, the video content has to be restricted by volume, and is often divided into a plurality of file segments for storing. As such, when watching a movie, a user has to execute multiple playing operations to play different file segments, which causes inconvenience of the user.

One conventional playing process of multimedia files is to play a selected one multimedia file, in which a heading file and index content of the selected multimedia file are analyzed first, and the multimedia file itself is played thereafter. When the playing of the selected multimedia file ends, the user may further select another multimedia file to play by repeating the aforementioned process.

Another conventional playing process is to establish a playing list of the multimedia files. The user is allowed to pre-select a plurality of multimedia files to be played, and the player will automatically complete the playing operation. First, a heading file and index content of the first multimedia file on the playing list are analyzed, and the first multimedia file itself is played thereafter. When the playing of the first multimedia file ends, other multimedia files can be played by repeating the aforementioned process. However, all of the above processes play the multiple multimedia files in a one by one manner. Therefore, when switching between different multimedia files, the multimedia files are to be repetitively initialized, which often cause discontinuity of the playing process, or even incapable of supporting fast forward/backward operation between different multimedia files.

Further, simply joining two multimedia file video segments together often causes problems, because timing units for video and audio are inconsistent with each other. For example, when playing a video with a frame rate of 30 frames per second, each data block spends 33 ms, while the time interval for sampling the audio block is determined according to a sampling frequency and the compression format. As such, lengths of the video and the audio of the multimedia files are inconsistent, so that joining multiple multimedia files together by using aforesaid method may cause asynchronous result of the video/audio playing.

### SUMMARY OF THE INVENTION

Accordingly, the present invention is directed to provide a method for seamless playback of multiple multimedia files, which is adapted to seamlessly play a plurality of multimedia files and provide fast forward/backward playing functions between different multimedia files, thus improving continuity of viewing multiple multimedia files.

For achieving the foregoing object and others, the present invention provides a method for seamless playback of multiple multimedia files, adapted for continuously playing a plurality of multimedia files with a player. The method includes the steps of: first, pre-analyzing a first multimedia file and a second multimedia file thus establishing a playing list; referring to index content of the first multimedia file and the second multimedia file to establish a first random access table and a second random access table; and playing the multimedia files according to the playing list.

According to an embodiment of the present invention, the step of playing the multimedia files according to the playing list includes aligning a start point of the second multimedia file with a signal boundary of television signals and starting to play the second multimedia file upon completeness of playing the first multimedia file, in which the signal boundary is a field boundary or a frame boundary.

According to an embodiment of the present invention, before the step of playing the multimedia files according to the playing list, the method further includes analyzing heading files of the multimedia files to obtain playing information of the multimedia files, analyzing index content of the multimedia files, and saving the analyzed index content in a memory of the player, and finally initializing the multimedia files and allocating memory resources of the player. The memory resources include image buffers, audio buffers, and random access buffers for playing the multimedia files.

According to an embodiment of the present invention, the step of allocating the memory resources of the player includes finding out the multimedia file requiring for most memory resources of the player from the heading files of the multimedia files, and initializing the player by serving the heading file of the multimedia file as initialization parameters of the player.

According to an embodiment of the present invention, the step of establishing the playing list includes: designating a file name word string of a seed file among the multimedia files to be played, then finding out other multimedia files matching with the file name word string to add to the playing list, and finally analyzing the heading files of the multimedia files to obtain playing information of the multimedia files so as to complete the setting of the playing list.

According to an embodiment of the present invention, the playing list includes file names of the multimedia files, file sizes of the multimedia files, content lengths of the multimedia files, shifts of media content deviating from the start points of the multimedia files, and video frame counts and video frame rates of the multimedia files.

According to an embodiment of the present invention, the step of setting the playing list includes: allowing a user to establish a playing sequence of the multimedia files.

According to an embodiment of the present invention, when the heading files of the multimedia files include a file name field of a next multimedia file, the step of establishing the playing list includes obtaining the file name for establishing the playing list by searching for the field.

According to an embodiment of the present invention, the method further includes recording timing information of a start point and an end point of the multimedia files.

According to an embodiment of the present invention, the step of playing the multimedia files includes establishing a basic time axis, and finding out positions of the start point and the end point on the basic time axis, in which the end point of the first multimedia file serves as the start point of the second multimedia file. The basic time axis includes a 90 kHz time axis.

According to an embodiment of the present invention, the step of playing the multimedia files includes receiving a skip playing instruction, finding out the multimedia file corresponding to the skip playing instruction and a position of a skip point in the multimedia file designated by the skip playing instruction according to positions of the multimedia files on the basic time axis and referring to the first random access table and the second random access table, and playing the multimedia files from the position of a skip point in the multimedia file.

According to an embodiment of the present invention, the step of playing the multimedia files includes obtaining a video frame count designated by the skip playing instruction, finding out the multimedia file corresponding to the video frame count by looking up the playing list, and converting the skip point designated by the skip playing instruction into a video frame count in the multimedia file, and playing the multimedia file according to the video frame count.

According to an embodiment of the present invention, the step of-playing the multimedia file includes obtaining a skip time point designated by the skip playing instruction, finding out the multimedia file corresponding to the skip time point by looking up the playing list, and converting the skip point designated by the skip playing instruction into a skip time point in the multimedia file, and playing the multimedia file according to the skip time point.

According to an embodiment of the present invention, when the position of the skip point designated by the skip playing instruction exceeds an end of a multimedia file, a next multimedia file is played from the start point of the next multimedia file.

According to an embodiment of the present invention, when the video data or the audio data of the second multimedia file has a delay time, the step of playing the second multimedia file includes aligning the start point of the second multimedia file to the signal boundary of the television signal, and starting to play the second multimedia file.

According to an embodiment of the present invention, when the video data or the audio data of the second multimedia file has a delay time, the step of playing the second multimedia file includes deducting the delay time from the time of the start point of the second multimedia file to obtain a new start point of the second multimedia file, aligning the new start point of the second multimedia file to the signal boundary of the television signal, and starting to play the second multimedia file.

The present invention establishes random access tables by pre-analyzing the heading files and the index content of the multimedia files and playing the multimedia files accordingly, in which upon completeness of playing each of the multimedia files, the start point of the next multimedia file is aligned with the signal boundary of television signals for playing. Therefore, the multiple multimedia files can be played seamlessly while the video and audio data are kept synchronized.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart of a method for seamless playback of multiple multimedia files according to an embodiment of the present invention.

FIG. 2 is a schematic diagram of a playing list of the multimedia files according to an embodiment of the present invention.

FIG. 3 is a schematic diagram illustrating start points of the multimedia files aligning with signal boundaries of television signals according to an embodiment of the present invention.

FIG. 4 is a schematic diagram illustrating delaying play of the multimedia files according to an embodiment of the present invention.

FIG. 5 is a flow chart of a method for seamless playback of multiple multimedia files according to an embodiment of the present invention.

FIG. 6 is a flow chart of a skip operation of multiple multimedia files according to an embodiment of the present invention.

FIG. 7 is a flow chart of a skip operation of multiple multimedia files according to an embodiment of the present invention.

FIG. 8 is schematic diagram illustrating a basic data flow of a player according to an embodiment of the present invention.

FIG. 9 is a schematic diagram of a skip operation of multiple multimedia files according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference counting numbers are used in the drawings and the description to refer to the same or like parts.

According to the present invention, in the beginning of playing multimedia files, a player obtains a playing list with multimedia files of the same file group, and considers all multimedia files listed in the playing list as a large virtual audio/video file and playing in accordance with the large virtual audio/video file. In practical operation, referring to the previously establish playing list, whenever playing of the content of a present multimedia file is completed, a next multimedia file is searched for, and a start point of the next multimedia file is aligned with a signal boundary of television signals so as to play the next multimedia file. In such a way, a seamless playback of the multiple multimedia files can be achieved. The present invention provides a method for seamless playback of multiple multimedia files in accordance with the aforementioned principle. Embodiments are to be given below for illustration purpose.

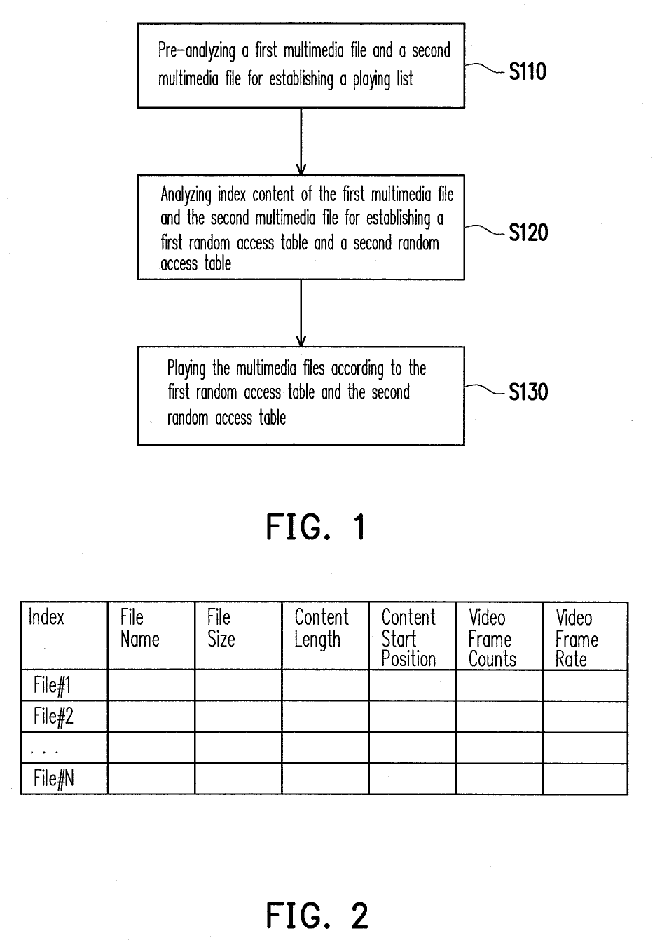

FIG. 1 is a flow chart of a method for seamless playback of multiple multimedia files according to an embodiment of the present invention. Referring to FIG. 1, the embodiment is adapted for continuously and seamlessly playing a plurality of multimedia files with a player. The embodiment includes the following steps.

First, at step S110, the player pre-analyzes a first multimedia files and a second multimedia file to establish a playing list. Specifically, when starting to play the plurality of multimedia files, the player obtains a playing list with multimedia files of the same file group. All multimedia files listed in the playing list as a whole is considered as a large virtual audio/video file. The large virtual audio/video file is thus played.

For example, FIG. 2 is a schematic diagram of a playing list of the multimedia files according to an embodiment of the present invention. Referring to FIG. 2, it shows a playing list 200 according to the embodiment. The playing list 200 includes file names of the multimedia files, files sizes of the multimedia files, content lengths of the multimedia files, shifts of media content deviating from the start points of the multimedia files, video frame counts of the multimedia files, and video frame rates of the multimedia files.

Then, at step S120, the player analyzes index content of the first multimedia file and the second multimedia file of the playing list, for respectively establishing a first random access table and a second random access table. Content of the first random access tables and the second random access tables are recorded in a suitable memory position of the player, such that it can be referred to by the player for subsequent access of the multimedia files.

Finally, at step S130, the player plays the multimedia files according to the playing list, and the first and the second random access tables. When the playing of the first multimedia file is completed, the player inquires the playing list to find out the second multimedia file to be continuously played. A start point of the second multimedia file is aligned with a signal boundary of the television signals so as to play the second multimedia file. The signal boundary is preferred to be but not restricted to be either a field boundary or a frame boundary.

In detail, simply joining two multimedia file video segments together often causes asynchronous result of the video/audio playing because timing units of the video and the audio are inconsistent with each other. For example, when playing a video with a frame rate of 30 frames per second, each data block spends 33 ms, while the time interval for sampling the audio block is determined according to a sampling frequency and the compression format. As such, it is apparent that lengths of the video and the audio of some multimedia files are inconsistent, so that after a plurality of multimedia files are played, asynchronous result of the video/audio playing occurs. Accordingly, the present invention plays the multimedia files in accordance with a timing means of television signals, in which prior to playing a next multimedia file, the video data and audio data of the next multimedia file are aligned with the field boundary or the frame boundary of the television signals, and then the next multimedia file is played. As such, even after playing a plurality of multimedia files, the audio data and the video data are also maintained synchronized.

Further, the present invention employs a 90 kHz time axis as a basic time axis for determining time positions of video segments, in which any video segment can be found with a corresponding point on the time axis. When start points of all multimedia file video segments are aligned according to the aforementioned method, time shifts corresponding thereto are also determined.

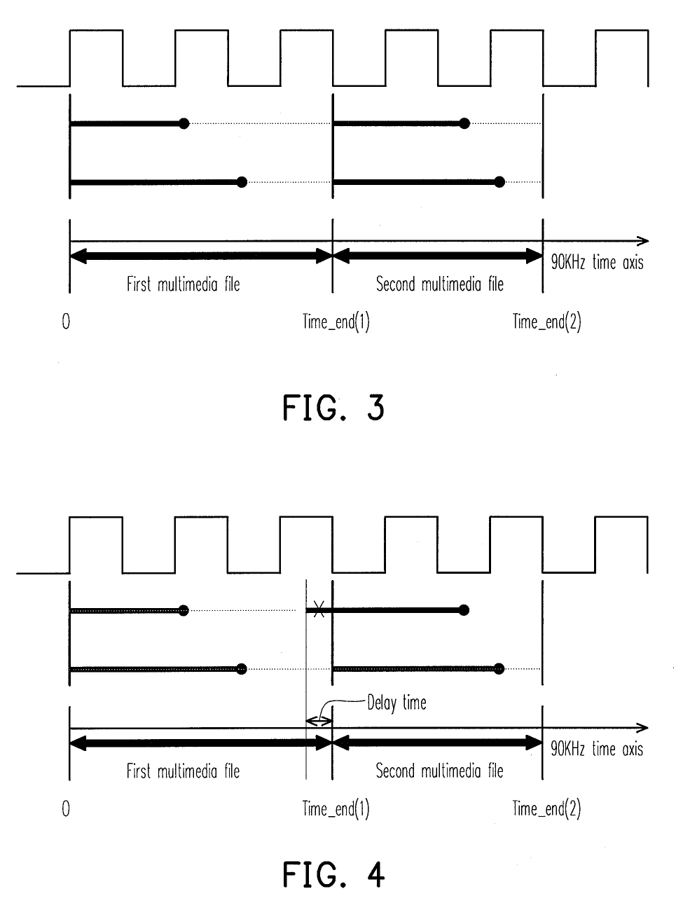

For example, FIG. 3 is a schematic diagram illustrating start points of the multimedia files aligning with signal boundaries of television signals according to an embodiment of the -present invention. Referring to FIG. 3, assuming that an original video segment of the first multimedia file is counted from Time 0, the timing of the first multimedia file is counted from Time 0 to Time_end(1). Further, when the second multimedia file is joined to the first multimedia file, the timing of the second multimedia file is counted from Tim_end(1) to Time_end(2). The player records timing information of start points and end points of each of the multimedia files, and determines which multimedia file is to be processed according to the timing information. For example, if lengths of these two multimedia files are 5 minutes and 3 minutes, respectively, it can be learnt according to the foregoing method that the operation during the seventh minute is processing the second multimedia file.

It should be noted that MPEG-4 allows a delay of a video data track. With respect to the delay of the data track, the present invention may either present the original delay by playing with the foregoing playing method, or neglect portions of the video data of the multimedia files which are not aligned.

In detail, when the video data or the audio data of the second multimedia file have a delay time, the player may either align the start point of the second multimedia file with the signal boundary of the television signals prior to playing the second multimedia file, or deduct the delay time from the time of the start point of the second multimedia file, and the result is taken as a new start point of the second multimedia file. The new start point of the second multimedia file is then aligned with the signal boundary of the television signals so as to play the second multimedia file.

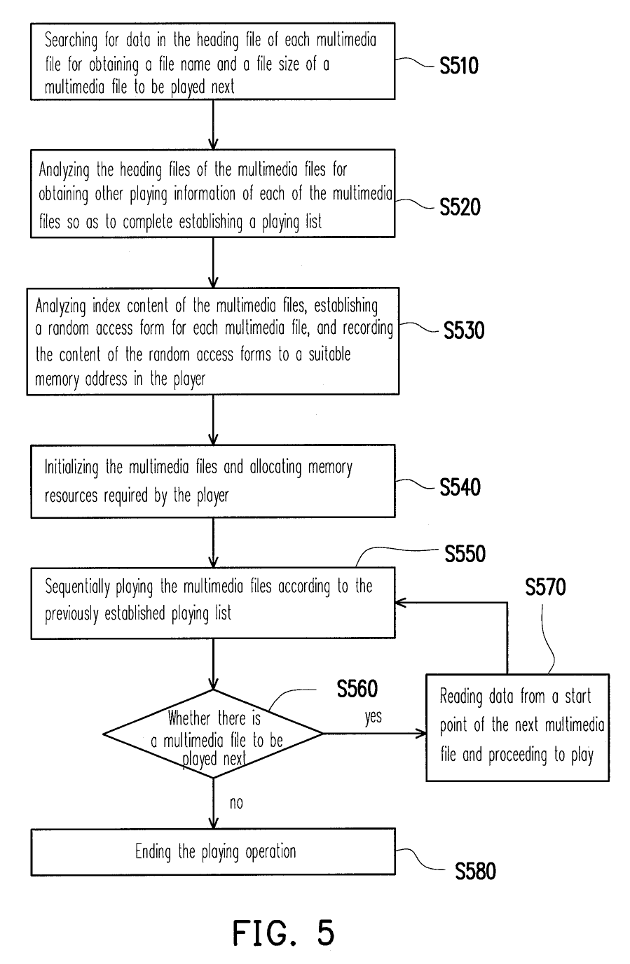

For example, FIG. 4 is a schematic diagram illustrating delaying play of the multimedia files according to an embodiment of the present invention. Referring to FIG. 4, a start time of the second multimedia file is Time_end(1) minus the delay time, and an end time of the second multimedia file is Time_end(2) minus the delay time. If, a first audio data is played at a time of 750 ms, the player outputs the voice after playing the video portion of the multimedia file for 750 ms. In other words, the player neglects the previous 750 ms video data, and takes the 750 ms as the start point of the multimedia file.

FIG. 5 is a flow chart of a method for seamless playback of multiple multimedia files according to an embodiment of the present invention. Referring to FIG. 5, the current embodiment further illustrates the seamless playback of multiple multimedia files of the previous embodiment in more details. The method includes the following steps.

Similar to the previous embodiment, in the current embodiment, the player also pre-analyzes the first multimedia file and the second multimedia file to establish a playing list. The player may obtain the playing list from the heading files of the multimedia files or the player itself.

In detail, the current embodiment introduces a field of chunk type into the heading files of the multimedia files. The chunk type field includes content of a file name of a multimedia file to be continuously played next after playing of a present multimedia file is completed. If there is no multimedia file to be continuously played next, the field of the chunk is filled with zero. Accordingly, the player can obtain the file name and file size of the multimedia file to be played next at step S510 by searching for data in the chunk of the heading file of each multimedia file.

In addition to the method of introducing the chunk type field for establishing the playing list, the present invention further allows the user to input a customized playing list by himself, or allows the player to use a mask for automatically establishing the playing list. The latter way is to designate a file name word string of a seed file among the multiple multimedia files (e.g., a prefix, a postfix, or a serial number word string of the file name, etc.) for finding out other multimedia files matching with the file name word string to add to the playing list.

Up to now, the playing list has only completed two types of fields, file names and file sizes, and at step S520, the player further analyzes the heading files of the multimedia files to obtain other playing information of the multimedia files including corresponding fields of multimedia file data, (e.g., content lengths of the multimedia files, shifts of media content deviating from the start points of the multimedia files, video frame counts of the multimedia files, and video frame rates of the multimedia files). With respect to the player, a general length of the virtual video file is the summation of video content of all of the multimedia files. In this step, the player can complete all uncompleted fields in the playing list.

After establishing the playing list, the player then executes an initialization operation to each multimedia file listed in the playing list. The initialization operation includes analyzing the index content of the multimedia files and establishing an individual random access table, and recording the content of the random access table to a suitable memory position in the player at step S530, which can be referred to by the player for subsequent access of the multimedia files.

At step S540, the multimedia files are initialized and memory resources of the player are allocated. Generally, memories of ordinary consumption type players are often provided for sharing. For example, image buffers, audio buffers, and random access buffers for playing the multimedia files are all basic resources commonly shared by the multimedia files. However, with limited resources, if more resources are allocated to a certain demand, resources that can be provided to another demand must be reduced. Accordingly, when playing the multimedia files, the present invention adopts a maximization resource allocation, so as to prevent increasing the complexity of the operation because the video buffer is needed for dynamic adjustment between different multimedia files.

In detail, the player finds out the multimedia file requiring for most memory resources of the player from the heading files of the multimedia files listed in the playing list, and initializes the player by serving the heading file of the multimedia file as initialization parameters of the player. The memory resources, for example, can be but are not restricted to be video buffers, audio buffers, or random access buffers required for playing the multimedia files. For example, each of the heading files includes a field for recording resolution of the multimedia file, and the player can find out the one having a maximum resolution from the multimedia files with respect to this field. And the maximum resolution is taken as the initialization parameter of the player.

When practically playing the multimedia files, the player sequentially plays the multimedia files at step S550 according to the previously established playing list. Specifically, when the playing of the present multimedia file is completed, the player looks up the playing list and searches for whether there is a multimedia file to be continuously played at step 560. If there is, then at step S570, the player reads data from the start point of the searched multimedia file. Otherwise, if there is no multimedia file to be continuously played, then at step S580, the playing operation is ended.

It should be noted herein that the player of the present invention also supports a skip operation for the foregoing virtual video file. In general, there are two types of skip operations. One type is to skip to a designated video frame, and another type is to skip to a designated time point. Each of these two types is to be exemplified with one embodiment herebelow.

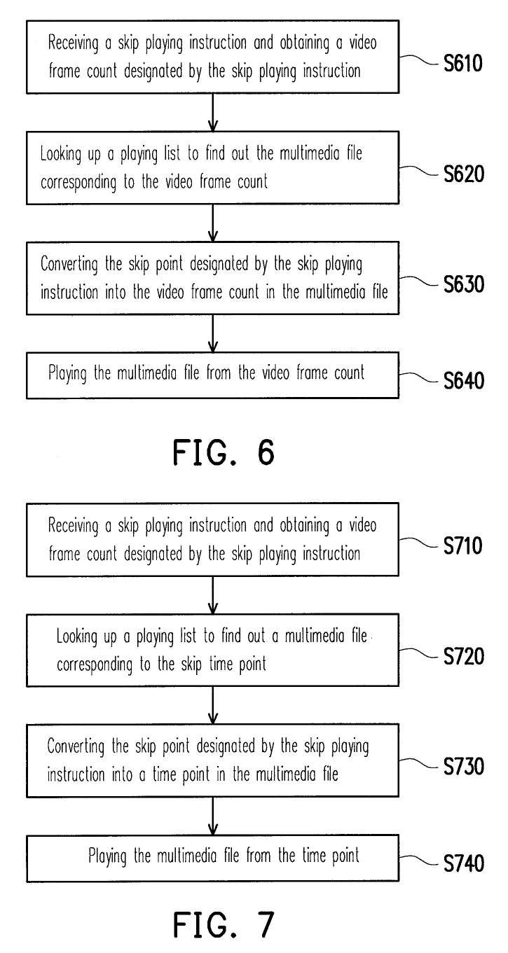

FIG. 6 is a flow chart of a skip operation of multiple multimedia files according to an embodiment of the present invention. Referring to FIG. 6, the embodiment illustrates skipping to a corresponding multimedia file according to a designated video frame by the control of the player. The flow includes the following steps:

First, at step S610, the player receives a skip playing instruction, and obtains a video frame count designated by the skip playing instruction. Then, the player finds out the multimedia file corresponding to the skip playing instruction and a position of a skip point in the multimedia file designated by the skip playing instruction according to positions of the multimedia files on a basic time axis and referring to the first random access table and the second random access table. At step S620, the player finds out the multimedia file corresponding to the video frame count by looking up the playing list. At step S630, the player converts the skip point designated by the skip playing instruction into the video frame count in the multimedia files. Finally, at step S640, the player plays the multimedia file from the video frame count.

FIG. 7 is a flow chart of a skip operation of multiple multimedia files according to an embodiment of the present invention. Referring to FIG. 7, the embodiment illustrates skipping to a corresponding multimedia file according to a designated time point by the control of the player. The flow includes the following steps:

First, at step S710, the player receives the skip playing instruction, and obtains a skip time point designated by the skip playing instruction. Then, at step S720, the player finds out a multimedia file corresponding to the skip time point by looking up the playing list. Then, at step S730, the player converts the skip point designated by the skip playing instruction into a time point in the multimedia file. And finally, at step S740, the player starts to play the multimedia file from the time point.

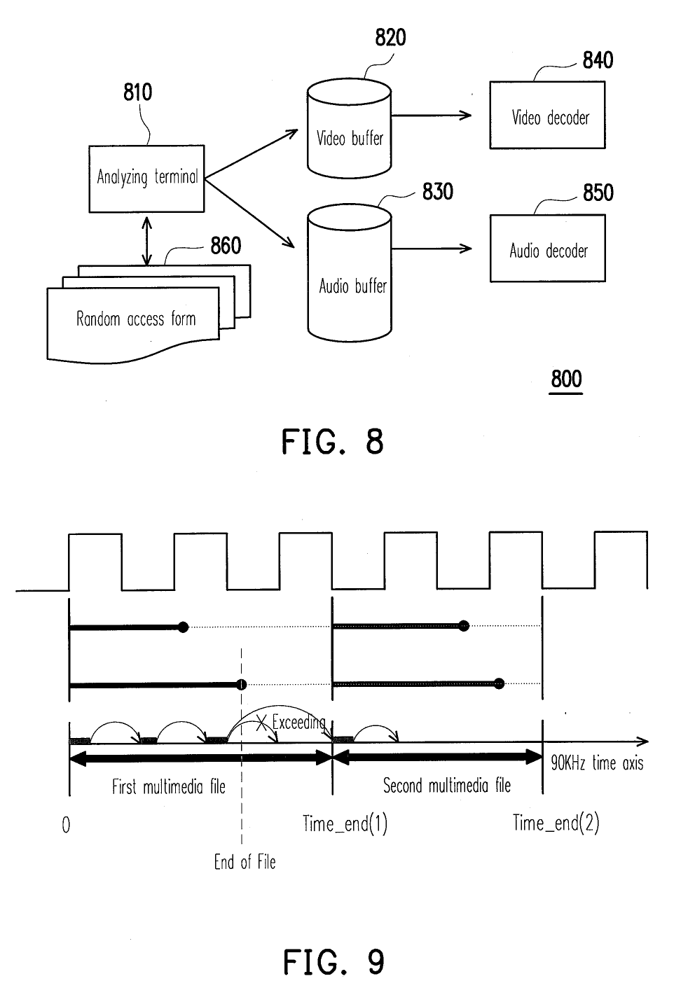

An embodiment is given below for further illustrating the structure of the player according to the present invention. FIG. 8 is schematic diagram illustrating a basic data flow of a player according to an embodiment of the present invention. Referring to FIG. 8, a player 800 of the present invention separates video data and audio data of the multimedia files by an analyzing terminal 810, and the video data and the audio data are filled in to a video buffer 820 and an audio buffer 830, respectively. Meanwhile a video decoder 840 and an audio decoder 850 read data from the video buffer 820 and the audio buffer 830, respectively and output decoded data for playing.

Specifically, during the process of sequentially playing the multimedia files, when the analyzing of the present multimedia file is completed, the analyzing terminal 810 continuously reads a next multimedia file to execute an analyzing operation, and meanwhile fills the analyzed data into the video buffer 820 and the audio buffer 830, respectively. On the other hand, the video decoder 840 and the audio decoder 850 read data from the video buffer 820 and the audio buffer 830 for decoding. The decoded data would not be outputted for playing until the start point of the new multimedia file is aligned. The foregoing process will not be felt much different for the user, but the multimedia files can be seamlessly played at the joining positions.

It should be noted herein that the player 800 needs to maintain a random access table 860 for executing a skip operation of fast forward/backward. The player 800 achieves skip operation by looking up the random access table 860. The method according to the present invention allows establishing corresponding random access tables 860 regarding to a variety of multimedia audio/video formats, so as to provide data for operation with the variety of multimedia audio/video formats, and thus supporting joining between different multimedia audio/video formats.

Further, when executing a skip operation, if a position of the skip point designated by the skip playing instruction exceeds an end of the multimedia file, the player plays a next multimedia file from a start point of the next multimedia file. For example, FIG. 9 is a schematic diagram of a skip operation of multiple multimedia files according to an embodiment of the present invention. Referring to FIG. 9, when the position of the skip point designated by the skip playing instruction exceeds the end of the first multimedia file, the player executes the operation of fast forward/backward from the start point of the second multimedia file. In such a way, the player is adapted to execute conventional skip operations without causing any discontinuity.

In summary, according to the method for seamless playback of multiple multimedia files of the present invention, a preset playing list and random access tables are employed for recording playing information of the multimedia files, so as to assure the audio/video synchronization when playing the multimedia files even if several files are skipped over, in which the playing time is continuously counted. Therefore, the present invention is adapted for seamlessly playing multiple multimedia files and providing fast forward/backward operation between different multimedia files, thus improving the continuity of viewing the multimedia files.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for seamless playback of multiple multimedia files, adapted for continuously playing a plurality of multimedia files with a player, the method comprising:
pre-analyzing a first multimedia file and a second multimedia file for establishing a playing list;
establishing a first random access table and a second random access table by referring to index content of the first multimedia file and the second multimedia file; and
playing the multimedia files according to the playing list, the first random access table, and the second random access table.

2. The method for seamless playback of multiple multimedia files according to claim 1, wherein the step of playing the multimedia files according to the playing list comprises:
aligning a start point of the second multimedia file with a signal boundary of television signals and starting to play the second multimedia file after the step of playing of the first multimedia file is completed.

3. The method for seamless playback of multiple multimedia files according to claim 2, wherein the signal boundary is a field boundary or a frame boundary.

4. The method for seamless playback of multiple multimedia files according to claim 1, before the step of playing the multimedia files according to the playing list, further comprising:
analyzing heading files of the multimedia files to obtain playing information of the multimedia files;
analyzing the index content of the multimedia files, and saving the analyzed index content in a memory of the player; and
initializing the multimedia files and allocating memory resources of the player.

5. The method for seamless playback of multiple multimedia files according to claim 4, wherein the step of allocating the memory resources of the player comprises:
finding out the multimedia file requiring for most memory resources of the player from the heading files of the multimedia files, and
initializing the player by serving the heading file of the multimedia file as initialization parameters of the player.

6. The method for seamless playback of multiple multimedia files according to claim 1, wherein the step of establishing the playing list comprises:
designating a file name word string of a seed file among the multimedia files to be played;
finding out other multimedia files matching with the file name word string to add to the playing list; and
analyzing the heading files of the multimedia files to obtain playing information of the multimedia files so as to complete the setting of the playing list.

7. The method for seamless playback of multiple multimedia files according to claim 1, wherein the playing list comprises file names of the multimedia files, file sizes of the multimedia files, content lengths of the multimedia files, shifts of media content deviating from the start points of the multimedia files, and video frame counts and video frame rates of the multimedia files.

8. The method for seamless playback of multiple multimedia files according to claim 1, wherein the step of setting the playing list comprises:
establishing a playing sequence of the multimedia files by a user.

9. The method for seamless playback of multiple multimedia files according to claim 1, wherein when the heading files of the multimedia files comprises a file name field of a next multimedia file, the step of establishing the playing list comprises:
obtaining the file name for establishing the playing list by searching for the field.

10. The method for seamless playback of multiple multimedia files according to claim 1, further comprising:
recording timing information of a start point and an end point of the multimedia files.

11. The method for seamless playback of multiple multimedia files according to claim 10, wherein the step of playing the multimedia files comprises:
establishing a basic time axis; and
finding out positions of the start point and the end point on the basic time axis, wherein the end point of the first multimedia file serves as the start point of the second multimedia file.

12. The method for seamless playback of multiple multimedia files according to claim 11, wherein the basic time axis includes a 90 kHz time axis.

13. The method for seamless playback of multiple multimedia files according to claim 11, wherein the step of playing the multimedia files comprises:
receiving a skip playing instruction;
finding out the multimedia file corresponding to the skip playing instruction and a position of a skip point in the multimedia file designated by the skip playing instruction according to positions of the multimedia files on the basic time axis and referring to the first random access table and the second random access table; and
playing the multimedia files from the position of the skip point in the multimedia file.

14. The method for seamless playback of multiple multimedia files according to claim 13, wherein the step of playing the multimedia files comprises:
obtaining a video frame count designated by the skip playing instruction;
finding out the multimedia file corresponding to the video frame count by looking up the playing list;
converting the skip point designated by the skip playing instruction into a video frame count in the multimedia file; and :
playing the multimedia file according to the video frame count.

15. The method for seamless playback of multiple multimedia files according to claim 13, wherein the step of playing the multimedia file comprises:
obtaining a skip time point designated by the skip playing instruction;
finding out the multimedia file corresponding to the skip time point by looking up the playing list;
converting the skip point designated by the skip playing instruction into a skip time point in the multimedia file; and
playing the multimedia file according to the skip time point.

16. The method for seamless playback of multiple multimedia files according to claim 13, wherein the step of playing the multimedia files comprises:
playing a next multimedia file starting from the start point of the next multimedia file when the position of the skip point designated by the skip playing instruction exceeds an end of the multimedia file.

17. The method for seamless playback of multiple multimedia files according to claim 10, wherein when the video data or the audio data of the second multimedia file has a delay time, the step of playing the second multimedia file comprises:
aligning the start point of the second multimedia file to the signal boundary of the television signal, and starting to play the second multimedia file.

18. The method for seamless playback of multiple multimedia files according to claim 10, wherein when the video data or the audio data of the second multimedia file has a delay time, the step of playing the second multimedia file comprises:
deducting the delay time from the time of the start point of the second multimedia file to obtain a new start point of the second multimedia file; and
aligning the new start point of the second multimedia file to the signal boundary of the television signal, and starting to play the second multimedia file.
